(19) United States
(12) Patent Application Publication
(10) Pub. No.: US 2025/0129647 A1
(43) Pub. Date: Apr. 24, 2025

(54) THREE-AXIS MISALIGNED INVISIBLE HINGE

(71) Applicants: Wenxun LIU, Zhejiang (CN); Mingyan WANG, Zhejiang (CN)

(72) Inventors: Wenxun LIU, Zhejiang (CN); Mingyan WANG, Zhejiang (CN)

(21) Appl. No.: 18/683,899

(22) PCT Filed: Aug. 12, 2022
(86) PCT No.: PCT/CN2022/111962

§ 371 Date: Feb. 15, 2024

(30) Foreign Application Priority Data
Aug. 16, 2021 (CN) 202110936206.5

(51) Int. Cl. E05D 3/10; E05D 5/02; E05D 7/00

(52) U.S. Cl. CPC E05D 3/10; E05D 5/02; E05D 7/00; E05Y 2201/624; E05Y 2600/41; E05Y 2900/132; E05Y 2900/148

(57) ABSTRACT

A three-axis misaligned invisible hinge, comprising a main hinge flap (1), a secondary hinge flap (2), an upper inclined piece (8) and a lower inclined piece (5), wherein the main hinge flap (1) is rotatably connected to one end of the upper inclined piece (8) by means of a main side shaft (7); the secondary hinge flap (2) is rotatably connected to one end of the lower inclined piece (5) by means of a secondary side shaft (4); the other end of the upper inclined piece (8) is rotatably connected to the other end of the lower inclined piece (5) by means of a common shaft (6); and the extension line of the main side shaft (7), the extension line of the secondary side shaft (4) and the extension line of the common shaft (6) intersect at a point.

### TECHNICAL FIELD

The present disclosure relates to the technical field of opening and closing mechanisms, and in particular to a three-axis misaligned invisible hinge.

### BACKGROUND

Hinge is a commonly used hardware accessory, which is usually used as the opening and closing mechanism of doors and windows. The existing hinges, when mounted, usually need to be slotted on both sides, the slotting depth is large, and the application scope is small. For materials of the same size, the bearing capacity is weak, the unfolded state is unsightly and lacks of stretch, and the practical application collocation effect is poor.

### SUMMARY

In order to solve the technical problem above, the present disclosure provides a three-axis misaligned invisible hinge.

To achieve the objective above, the present disclosure provides the following solutions:

A three-axis misaligned invisible hinge provided by the present disclosure includes a main hinge flap, a secondary hinge flap, an upper inclined piece, and a lower inclined piece. The main hinge flap is rotatably connected to one end of the upper inclined piece by means of main side shaft. The secondary hinge flap is rotatably connected to one end of the lower inclined piece by means of a secondary side shaft. The other end of the upper inclined piece is rotatably connected to the other end of the lower inclined piece by means of a common shaft. An extension line of the main side shaft, an extension line of the secondary side shaft and an extension line of the common shaft intersect at a point.

Alternatively, the main hinge flap is provided with at least two upper inclined pieces, and the secondary hinge flap is provided with at least two lower inclined pieces. All upper inclined pieces on the main hinge flap are symmetrically distributed, and all lower inclined pieces on the secondary hinge flap are symmetrically distributed.

Alternatively, the main hinge flap is provided with at least two upper inclined pieces, and the secondary hinge flap is provided with at least two lower inclined pieces. All upper inclined pieces on the main hinge flap are distributed in parallel, and all lower inclined pieces on the secondary hinge flap are distributed in parallel.

Alternatively, in a folded state, the main side shaft, the secondary side shaft and the common shaft are located in the same plane.

Alternatively, the secondary hinge flap is provided with an accommodating groove for accommodating the folded upper inclined piece and the folded lower inclined piece.

Alternatively, in a folded state, one side, towards the upper inclined piece, of the lower inclined piece is provided with a groove for accommodating the upper inclined piece.

Alternatively, each of the main hinge flap and the secondary hinge flap is provided with multiple mounting through holes.

Compared with the prior art, the present disclosure obtains the following technical effects:

The three-axis misaligned invisible hinge provided by the present disclosure has stronger bearing capacity, wider and better product size control and wider application field. The three-axis misaligned structure makes the hinge more visually pleasant in unfolded form, more in line with the application of actual products, and easier to open.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural diagram of a three-axis misaligned invisible hinge according to the present disclosure;

FIG. 2 is a structural diagram of a three-axis misaligned invisible hinge according to the present disclosure in a folded state;

FIG. 3 is a second structural diagram of a three-axis misaligned invisible hinge according to the present disclosure;

FIG. 4 is a third structural diagram of a three-axis misaligned invisible hinge according to the present disclosure;

FIG. 5 is a fourth structural diagram of a three-axis misaligned invisible hinge according to the present disclosure.

In the drawings: 1—main hinge flap; 2—secondary hinge flap; 3—accommodating groove; 4—secondary side shaft; 5—lower inclined piece; 6—common shaft; 7—main side shaft; 8—upper inclined piece.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

### Embodiment 1

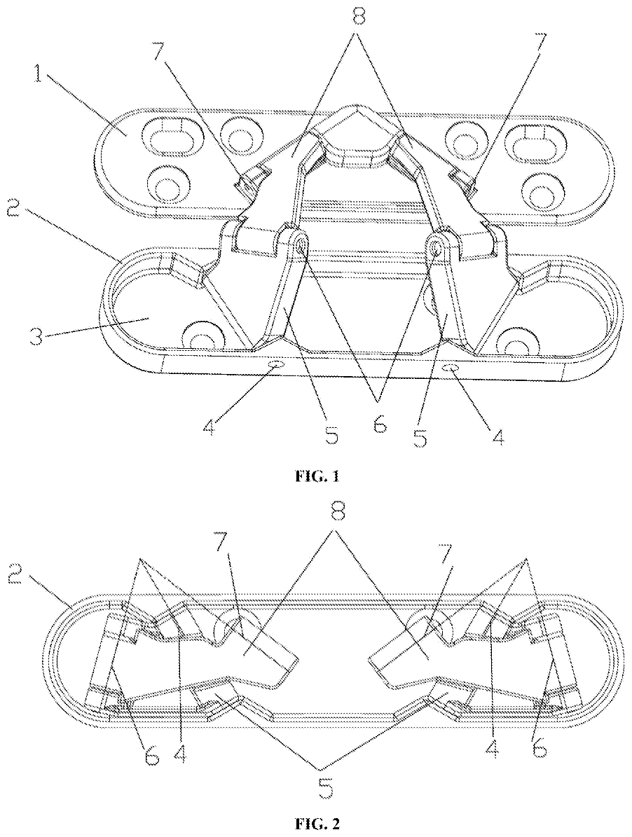

As shown in FIG. 1 and FIG. 2, a three-axis misaligned invisible hinge is provided by this embodiment, including a main hinge flap 1, a secondary hinge flap 2, an upper inclined piece 8, and a lower inclined piece 5. The main hinge flap 1 is rotatably connected to one end of the upper inclined piece 8 by means of a main side shaft 7, and the secondary hinge flap 2 is rotatably connected to one end of the lower inclined piece 5 by means of a secondary side shaft 4. The other end of the upper inclined piece 8 is rotatably connected to the other end of the lower inclined piece 5 by means of a common shaft 6. An extension line of the main side shaft 7, an extension line of the secondary side shaft 4 and an extension line of the common shaft 6 intersect at a point.

In a specific embodiment, the main hinge flap 1 is provided with at least two upper inclined pieces 8, and the secondary hinge flap 2 is provided with at least two lower inclined pieces 5. The two upper inclined pieces 8 are symmetrically distributed, and the two lower inclined pieces 5 are symmetrically distributed. More specifically, an intersection of the two upper inclined pieces 8 and the extension line of the main side shaft 7 connected to the main hinge flap 1 is located at a center line of the main hinge flap 1, and an intersection of the two lower inclined pieces 5 and the extension line of the secondary side shaft 4 connected to the secondary hinge flap 2 is located at a center line of the secondary hinge flap 2.

In order to further reduce the volume of the hinge after folding, the secondary hinge flap 2 is provided with an accommodating groove 3 for accommodating the folded upper inclined piece 8 and the folded lower inclined piece 5. One side, facing the upper inclined piece 8, of the lower inclined piece 5 is provided with a groove for accommodating the upper inclined piece 8. In a folded state, the upper inclined piece 8 is accommodated in the groove of the lower inclined piece 5, and the lower inclined piece 5 is accommodated in the accommodating groove 3 of the secondary hinge flap 2. The main side shaft 7, the secondary side shaft 4, and the common shaft 6 are located in the same plane, thus buckling the main hinge flap 1 on the secondary hinge flap 2. A minimum thickness of the three-axis misaligned invisible hinge in the folded state is the thickness of the secondary hinge flap 2.

In order to facilitate the mounting, each of the main hinge flap 1 and the secondary hinge flap 2 is provided with multiple mounting through holes. One side, facing an inner side, of each mounting through hole is provided with a counter bore, such that ends of screws can be hidden in the counter bore after the main hinge flap 1 and the secondary hinge flap 2 are mounted to the door and window and other structures by the screws, and the internal space of the three-axis misaligned invisible hinge is not occupied on the premise of ensuring the mounting strength, which is beneficial to reducing the overall thickness of the three-axis misaligned invisible hinge and further reducing the mounting space occupied by the three-axis misaligned invisible hinge.

### Embodiment 2

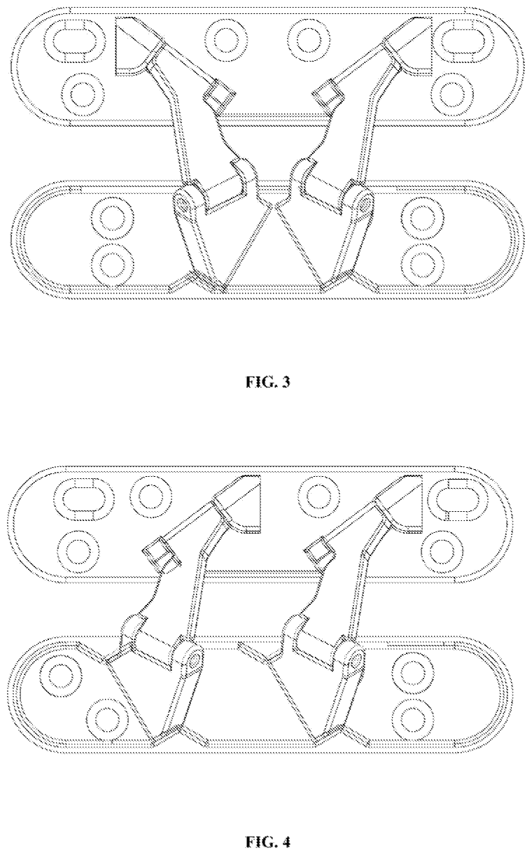

As shown in FIG. 3, in this embodiment, all main side shafts 7 on the main hinge flap 1 are symmetrically distributed along a middle part of the middle hinge flap 1, and all secondary side shafts 4 on the secondary hinge flap 2 are symmetrically distributed along a middle part of the secondary hinge flap 2.

### Embodiment 3

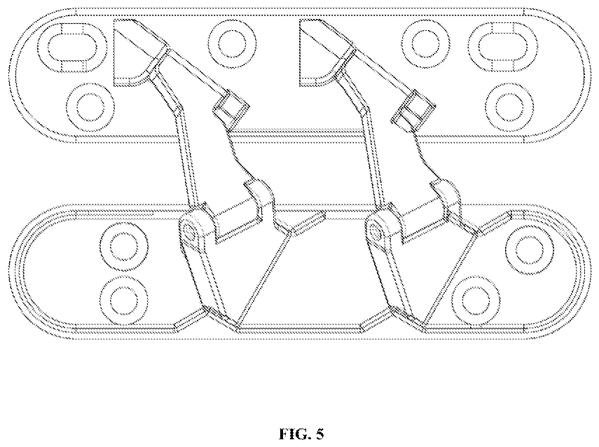

As shown in FIG. 4, in this embodiment, all main side shafts 7 on the main hinge flap 1 are distributed in parallel, and all secondary side shafts 4 on the secondary hinge flap 2 are distributed in parallel.

### Embodiment 4

As shown in FIG. 5, in this embodiment, all main side shafts 7 on the main hinge flap 1 are distributed in parallel, and all secondary side shafts 4 on the secondary hinge flap 2 are distributed in parallel.

It should be noted that: for those skilled in the art, apparently, the present disclosure is not limited to details of the exemplary embodiments, and may be expressed in other specific forms without departing from the spirit or basic characteristics of the present disclosure. Therefore, in any way, the embodiments should be regarded as exemplary, not limitative; and the scope of the present disclosure is limited by the appended claims, instead of the above description. Thus, all variations intended to fall into the meaning and scope of equivalent elements of the claims should be covered within the present disclosure. Any reference signs in the claims shall not be regarded as limitations to the concerned claims.

Several examples are used for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

1. A three-axis misaligned invisible hinge, comprising a main hinge flap, a secondary hinge flap, an upper inclined piece, and a lower inclined piece, wherein the main hinge flap is rotatably connected to one end of the upper inclined piece by means of a main side shaft; the secondary hinge flap is rotatably connected to one end of the lower inclined piece by means of a secondary side shaft; the other end of the upper inclined piece is rotatably connected to the other end of the lower inclined piece by means of a common shaft; and an extension line of the main side shaft, an extension line of the secondary side shaft and an extension line of the common shaft intersect at a point.

2. The three-axis misaligned invisible hinge according to claim 1, wherein the main hinge flap is provided with at least two upper inclined pieces, and the secondary hinge flap is provided with at least two lower inclined pieces; and all upper inclined pieces on the main hinge flap are symmetrically distributed, and all lower inclined pieces on the secondary hinge flap are symmetrically distributed.

3. The three-axis misaligned invisible hinge according to claim 1, wherein the main hinge flap is provided with at least two upper inclined pieces, and the secondary hinge flap is provided with at least two lower inclined pieces; and all upper inclined pieces on the main hinge flap are distributed in parallel, and all lower inclined pieces on the secondary hinge flap are distributed in parallel.

4. The three-axis misaligned invisible hinge according to claim 1, wherein in a folded state, the main side shaft, the secondary side shaft and the common shaft are located in the same plane.

5. The three-axis misaligned invisible hinge according to claim 1, wherein the secondary hinge flap is provided with an accommodating groove for accommodating the folded upper inclined piece and the folded lower inclined piece.

6. The three-axis misaligned invisible hinge according to claim 1, wherein, in a folded state, one side, facing the upper inclined piece, of the lower inclined piece is provided with a groove for accommodating the upper inclined piece.

7. The three-axis misaligned invisible hinge according to claim 1, wherein each of the main hinge flap and the secondary hinge flap is provided with a plurality of mounting through holes.

8. The three-axis misaligned invisible hinge according to claim 2, wherein the secondary hinge flap is provided with an accommodating groove for accommodating the folded upper inclined piece and the folded lower inclined piece.

9. The three-axis misaligned invisible hinge according to claim 3, wherein the secondary hinge flap is provided with an accommodating groove for accommodating the folded upper inclined piece and the folded lower inclined piece.

10. The three-axis misaligned invisible hinge according to claim 4, wherein the secondary hinge flap is provided with an accommodating groove for accommodating the folded upper inclined piece and the folded lower inclined piece.

11. The three-axis misaligned invisible hinge according to claim 2, wherein, in a folded state, one side, facing the upper inclined piece, of the lower inclined piece is provided with a groove for accommodating the upper inclined piece.

12. The three-axis misaligned invisible hinge according to claim 3, wherein, in a folded state, one side, facing the upper inclined piece, of the lower inclined piece is provided with a groove for accommodating the upper inclined piece.

13. The three-axis misaligned invisible hinge according to claim 4, wherein, in a folded state, one side, facing the upper inclined piece, of the lower inclined piece is provided with a groove for accommodating the upper inclined piece.

14. The three-axis misaligned invisible hinge according to claim 2, wherein each of the main hinge flap and the secondary hinge flap is provided with a plurality of mounting through holes.

15. The three-axis misaligned invisible hinge according to claim 3, wherein each of the main hinge flap and the secondary hinge flap is provided with a plurality of mounting through holes.

16. The three-axis misaligned invisible hinge according to claim 4, wherein each of the main hinge flap and the secondary hinge flap is provided with a plurality of mounting through holes.
